(19) United States
(12) Patent Application Publication
(10) Pub. No.: US 2014/0062986 A1
(43) Pub. Date: Mar. 6, 2014

(54) DRIVING CIRCUIT CHIP AND DRIVING METHOD FOR DISPLAY

(71) Applicant: AU OPTRONICS CORP., Hsin-Chu (TW)

(72) Inventors: WEN-CHIANG HUANG, Hsin-Chu (TW); CHUN-FAN CHUNG, Hsin-Chu (TW); YU-HSI HO, Hsin-Chu (TW)

(73) Assignee: AU Optronics Corp., Hsin-Chu (TW)

(21) Appl. No.: 13/858,158

(22) Filed: Apr. 8, 2013

(30) Foreign Application Priority Data
Aug. 29, 2012 (TW) 101131331

(51) Int. Cl. G09G 3/36

(52) U.S. Cl. CPC G09G 3/3696
USPC 345/212

(57) ABSTRACT

A driving method for a display apparatus used in a driving circuit chip, includes: receiving first and second voltages; outputting the first and second voltages to a first input-stage circuit of a first amplifier and a second input-stage circuit of a second amplifier, respectively, in a first period; outputting the first and second voltages to the second input-stage circuit and the first input-stage circuit, respectively, in a second period; receiving a third voltage outputted from the first input-stage circuit and a fourth voltage outputted from the second input-stage circuit; outputting the third and fourth voltages to the first and second output-stage circuits, respectively, in the first period; and outputting the third and fourth voltages to the second and first output-stage circuits, respectively, in the second period. A driving circuit chip is also provided.

### TECHNICAL FIELD

The present disclosure relates to a driving circuit chip and a driving method, and more particularly to a driving circuit chip and a driving method used in a display.

### BACKGROUND

The brightness level capable of being distinguished by normal people has an exponential rather than a linear distribution. For example, people may only distinguish the one nit difference in an environment having a brightness up to 100; but able to distinguish 0.01 nit difference in a dim environment having a brightness of one nit. In other words, people have a sharper visual sensitivity on dark images rather than bright images. According to the aforementioned characteristic, the gamma curve is widely used in the display technology. Gamma curve is a relationship between a gray scale and a brightness of a display. Because the gray scale may be represented by a voltage, the gamma curve may also indicate a response relationship between an input voltage and a brightness of a display.

FIG. 1A is a schematic view illustrating a source driver chip 10 and an associated gamma voltage divider circuit 101 of a display apparatus. As shown, the gamma voltage divider circuit 101 is configured to provide a plurality of voltage with different voltage levels to a resistor string 102 in the source driver chip 10 thereby generating a plurality of required gray scales (e.g., V₀˜V₂₅₅). To generate a sufficient driving power to the resistor string 102 in the source driver chip 10, basically the resistors in the gamma voltage divider circuit 101 are designed to have a relatively-small resistance value, compared with other associated resistors, for a generation of a relatively-large current, compared with other associated currents.

Because of the circuit design illustrated in FIG. 1A may result in a large energy consumption, another source driver chip is developed as shown in FIG. 1B. As shown, the main difference between the source driver chip 10 in FIG. 1A and the source driver chip 20 in FIG. 1B is that the source driver chip 20 further includes a plurality of negative feedback operational amplifiers 200 for the increasing of the driving capacity. As a result, the associated external gamma voltage divider circuit 201 is not required to supply a large current to the source driver circuit chip 20, and consequentially the resistors in the resistor string 202 in the gamma voltage divider circuit 201 can be designed to have a large resistance value. Thus, the current flowing through the resistor string 202 decreases and accordingly lower power consumption is realized.

With the liquid crystal display increasing in size, it is pretty common to employ more than one source driver chips for driving different areas in a liquid crystal display. However, different source driver chips may have the different circuit characteristics due to the manufacturing process variations; the input-stage circuits in the negative feedback operational amplifiers 200 in different source driver chips may have different offset voltages. Thus, the output voltages, outputted from negative feedback operational amplifiers 200 in different source driver chips, may have different voltage values, and accordingly the different areas with the same gray scale may present different brightness, which is so called V-band.

### SUMMARY

An embodiment of the disclosure is to provide a driving circuit chip, which includes a first amplifier, a second amplifier, a first switching device and a second switching device. The first amplifier includes a first input-stage circuit and a first output-stage circuit. The second amplifier includes a second input-stage circuit and a second output-stage circuit. The first switching device is electrically connected to a first gamma voltage divider circuit, a second gamma voltage divider circuit, the first amplifier and the second amplifier. The first switching device is configured to receive a first voltage and a second voltage respectively outputted from the first gamma voltage divider circuit and the second gamma voltage divider circuit; output the first voltage and the second voltage to the first input-stage circuit of the first amplifier and the second input-stage circuit of the second amplifier, respectively, in a first period; and output the first voltage and the second voltage to the second input-stage circuit of the second amplifier and the first input-stage circuit of the first amplifier, respectively, in a second period. The second switching device is electrically connected to the first amplifier and the second amplifier. The second switching device is configured to receive a third voltage and a fourth voltage respectively outputted from the first input-stage circuit of the first amplifier and the second input-stage circuit of the second amplifier; output the third voltage and the fourth voltage to the first output-stage circuit of the first amplifier and the second output-stage circuit of the second amplifier, respectively, in the first period; and output the third voltage and the fourth voltage to the second output-stage circuit of the second amplifier and the first output-stage circuit of the first amplifier, respectively, in the second period.

Another embodiment of the disclosure is to provide a driving method for a display apparatus used in a driving circuit chip. The display apparatus includes a first gamma voltage divider circuit and a second gamma voltage divider circuit. The driving circuit chip includes a first amplifier and a second amplifier. The first amplifier includes a first input-stage circuit and a first output-stage circuit. The second amplifier includes a second input-stage circuit and a second output-stage circuit. The driving method includes steps of: receiving a first voltage outputted from the first gamma voltage divider circuit and a second voltage outputted from the second gamma voltage divider circuit; outputting the first voltage and the second voltage to the first input-stage circuit of the first amplifier and the second input-stage circuit of the second amplifier, respectively, in a first period; outputting the first voltage and the second voltage to the second input-stage circuit of the second amplifier and the first input-stage circuit of the first amplifier, respectively, in a second period; receiving a third voltage outputted from the first input-stage circuit of the first amplifier and a fourth voltage outputted from the second input-stage circuit of the second amplifier; outputting the third voltage and the fourth voltage to the first output-stage circuit of the first amplifier and the second output-stage circuit of the second amplifier, respectively, in the first period; and outputting the third voltage and the fourth voltage to the second output-stage circuit of the second amplifier and the first output-stage circuit of the first amplifier, respectively, in the second period.

### BRIEF DESCRIPTION OF THE DRAWINGS

The present disclosure will become more readily apparent to those ordinarily skilled in the art after reviewing the following detailed description and accompanying drawings, in which:

FIG. 1A is a schematic view illustrating a source driver chip and an associated gamma voltage divider circuit of a conventional display apparatus;

FIG. 1B is another schematic view illustrating a source driver chip and an associated gamma voltage divider circuit of a conventional display apparatus;

FIG. 2A is an internal functional block view of the aforementioned negative-feedback operational amplifier shown in FIG. 1B;

FIGS. 2B, 2C are functional block views of a driving circuit chip in accordance with an embodiment of the present disclosure;

FIGS. 3A, 3B are schematic views illustrating the operation processes of the driving circuit chip of the present disclosure in the first period;

FIGS. 3C, 3D are schematic views illustrating the operation processes of the driving circuit chip of the present disclosure in the second period;

FIG. 3E is a schematic views illustrating the voltage variations of the reference voltages in the driving circuit chip of the present disclosure;

FIGS. 4A, 4B are schematic views illustrating another operation processes of the driving circuit chip of the present disclosure in the first period; and

FIGS. 4C, 4D are schematic views illustrating another operation processes of the driving circuit chip of the present disclosure in the second period.

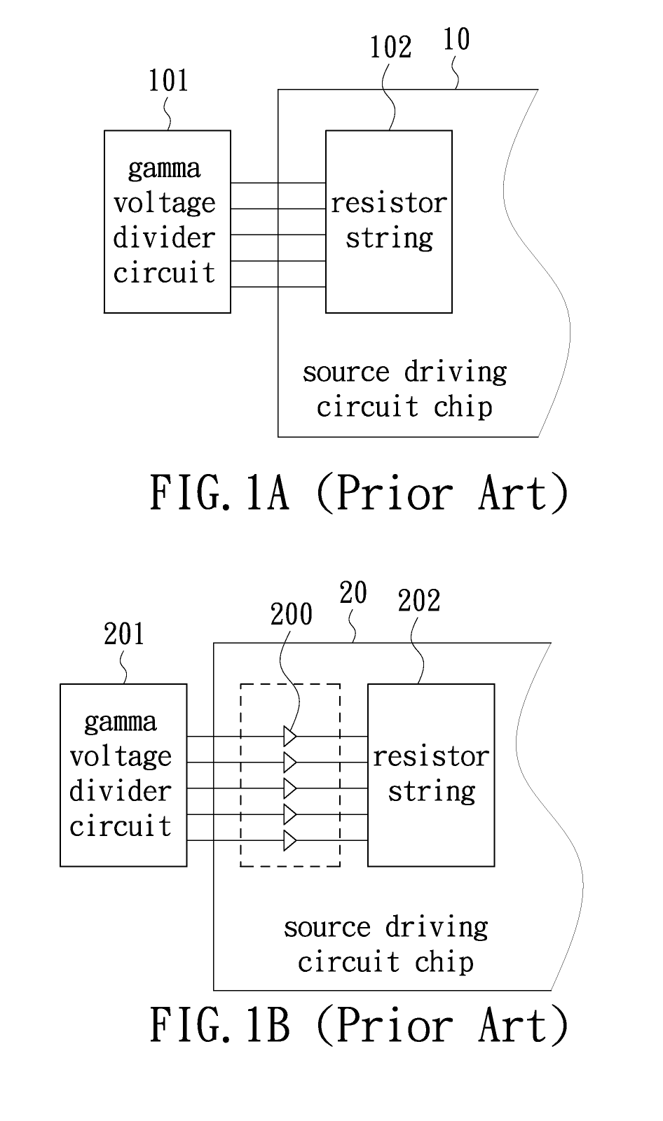

### DETAILED DESCRIPTION OF PREFERRED EMBODIMENTS

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

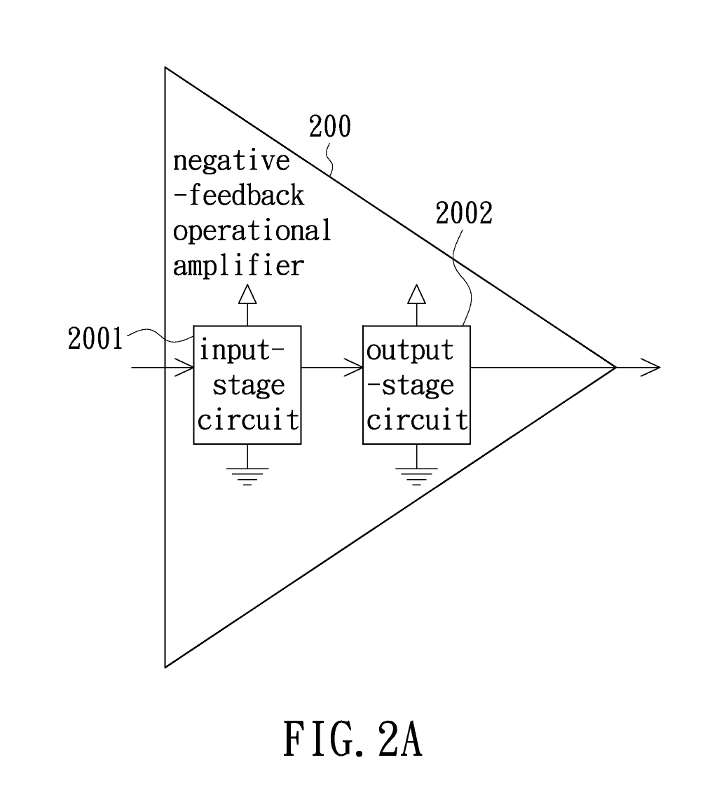

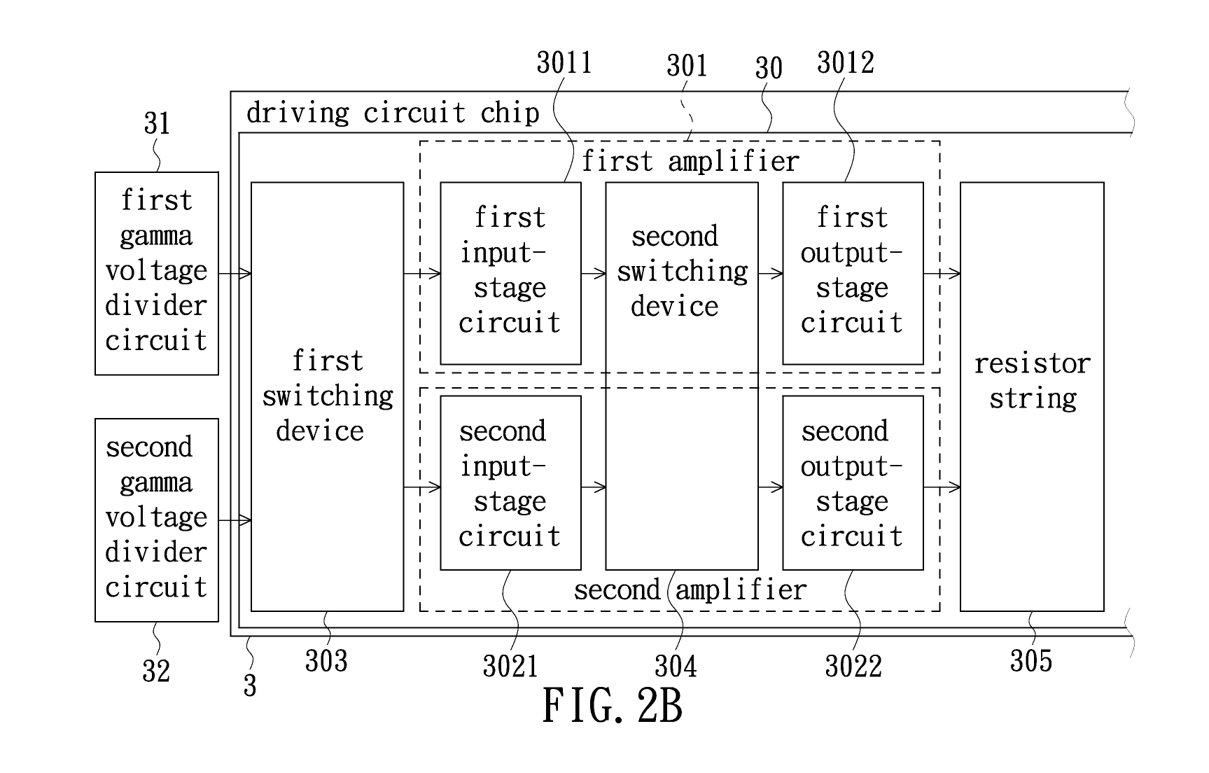

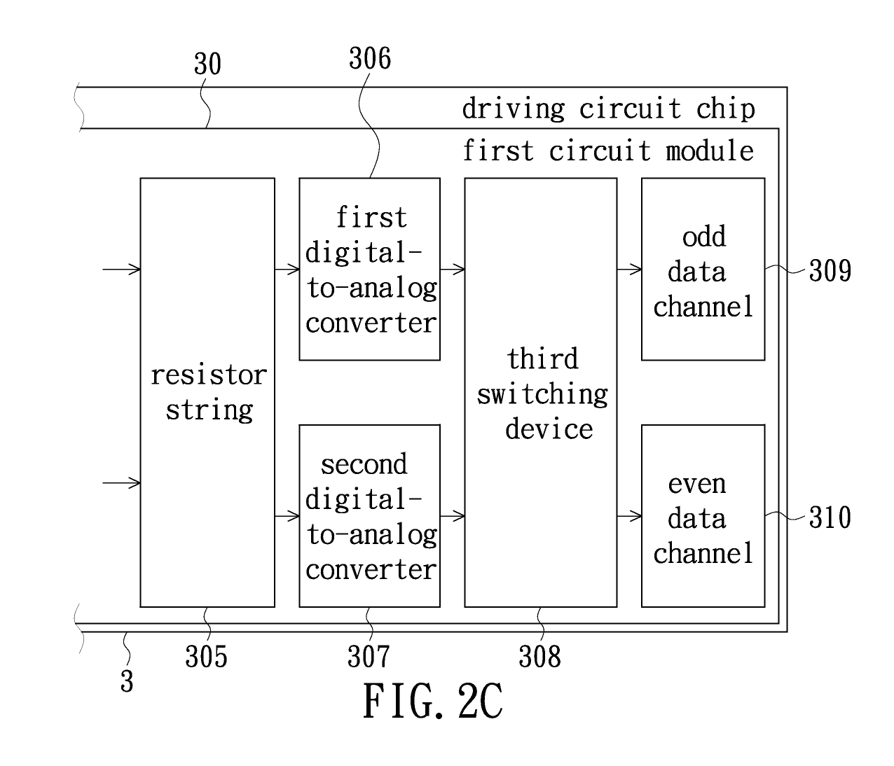

FIG. 2A is an internal functional block view of the aforementioned negative-feedback operational amplifier 200. Basically, the negative-feedback operational amplifier 200 is defined into two parts, which are an input-stage circuit 2001 configured to receive an input voltage from external and an output-stage circuit 2002 configured to generate an output voltage.

FIGS. 2B, 2C functional block views of a driving circuit chip in accordance with an embodiment of the present disclosure; wherein only the parts related to the present disclosure are shown. As shown, the driving circuit chip 3 in this embodiment may be used with a display apparatus (not shown), which includes a first gamma voltage divider circuit 31 and a second gamma voltage divider circuit 32. The first gamma voltage divider circuit 31 and the second gamma voltage divider circuit 32 are configured to generate a positive gamma voltage and a negative gamma voltage, respectively. Specifically, the first gamma voltage divider circuit 31 is configured to generate a group of voltage constituted of positive gamma voltages VGMA1˜VGMA7 (not shown) and the second gamma voltage divider circuit 32 is configured to generate a group of voltage constituted of negative gamma voltages VGMA8˜VGMA14 (not shown); wherein the VGMA1˜VGMA7 and the VGMA8˜VGMA14 are configured to have the same amplitude but opposite polarities, respectively.

The driving circuit 3 includes a plurality of circuit modules with the same circuit structure; wherein to facilitate a better understanding of the present embodiment, it is to be noted that the driving circuit chip 3 is exemplified by having a first circuit module 30 only. As shown in FIG. 2B, the first circuit module 30 includes a first amplifier 301 and a second amplifier 302. The first amplifier 301 includes a first input-stage circuit 3011 and a first output-stage circuit 3012; and the second amplifier 302 includes a second input-stage circuit 3021 and a second output-stage circuit 3022.

In one embodiment, a first switching device 303 and a second switching device 304 is arranged in the first circuit module 30. The first switching device 303, electrically connected between the first gamma voltage divider circuit 31 as well as the second gamma voltage divider circuit 32 and the first amplifier 301 as well as the second amplifier 302, is configured to receive, for example, the first voltage VGMA1 outputted from the first gamma voltage divider circuit 31 and the second voltage VGMA14 outputted from the second gamma voltage divider circuit 32; output the first voltage VGMA1 and the second voltage VGMA14 to the first input-stage circuit 3011 of the first amplifier 301 and the second input-stage circuit 3021 of the second amplifier 302, respectively, in a first period; and output the first voltage VGMA1 and the second voltage VGMA14 to the second input-stage circuit 3021 of the second amplifier 302 and the first input-stage circuit 3011 of the first amplifier 301, respectively, in a second period.

The second switching device 304, electrically connected between the first input-stage circuit 3011 of the first amplifier 301 as well as the second input-stage circuit 3021 of the second amplifier 302 and the first output-stage circuit 3012 of the first amplifier 301 as well as the second output-stage circuit 3022 of the second amplifier 302, is configured to receive a third voltage (not shown) outputted from the first input-stage circuit 3011 of the first amplifier 301 and a fourth voltage (not shown) outputted from the second input-stage circuit 3021 of the second amplifier 302; output the third voltage and the fourth voltage to the first output-stage circuit 3012 of the first amplifier 301 and the second output-stage circuit 3022 of the second amplifier 302, respectively, in the first period; and output the third voltage and the fourth voltage to the second output-stage circuit 3022 of the second amplifier 302 and the first output-stage circuit 3012 of the first amplifier 301, respectively, in the second period.

A resistor string module 305, electrically connected to the first output-stage circuit 3012 of the first amplifier 301 and the second output-stage circuit 3022 of the second amplifier 302, is configured to convert a fifth voltage (not shown) outputted from the first output-stage circuit 3012 and a sixth voltage (not shown) outputted from the second output-stage circuit 3022 into a first group of reference voltage (not shown) and a second group of reference voltage (not shown), respectively. A first digital-to-analog converter 306, electrically connected to the resistor string module 305, is configured to generate a first analog voltage by performing a digital-to-analog conversion on first digital data (not shown) with reference of the first group of reference voltage. A second digital-to-analog converter 307, electrically connected to the resistor string module 305, is configured to generate a second analog voltage by performing the digital-to-analog conversion on second digital data (not shown) with reference of the second group of reference voltage. A third switching device 308, electrically connected between the first digital-to-analog converter 306 as well as the second digital-to-analog converter 307 and an odd data channel 309 as well as an even data channel 310, is configured to transmit the first analog voltage and the second analog voltage to the odd data channel 309 and the even data channel 310, respectively, in the first period and transmit the second analog voltage and the first analog voltage to the odd data channel 309 and the even data channel 310, respectively, in the second period; wherein the first analog voltage and the second analog voltage are used to control the odd data lines and the even data lines of the display apparatus (e.g., a liquid crystal display), respectively. It is understood that the other not-shown circuit modules each have the same aforementioned circuit structure, and no redundant detail is to be given herein.

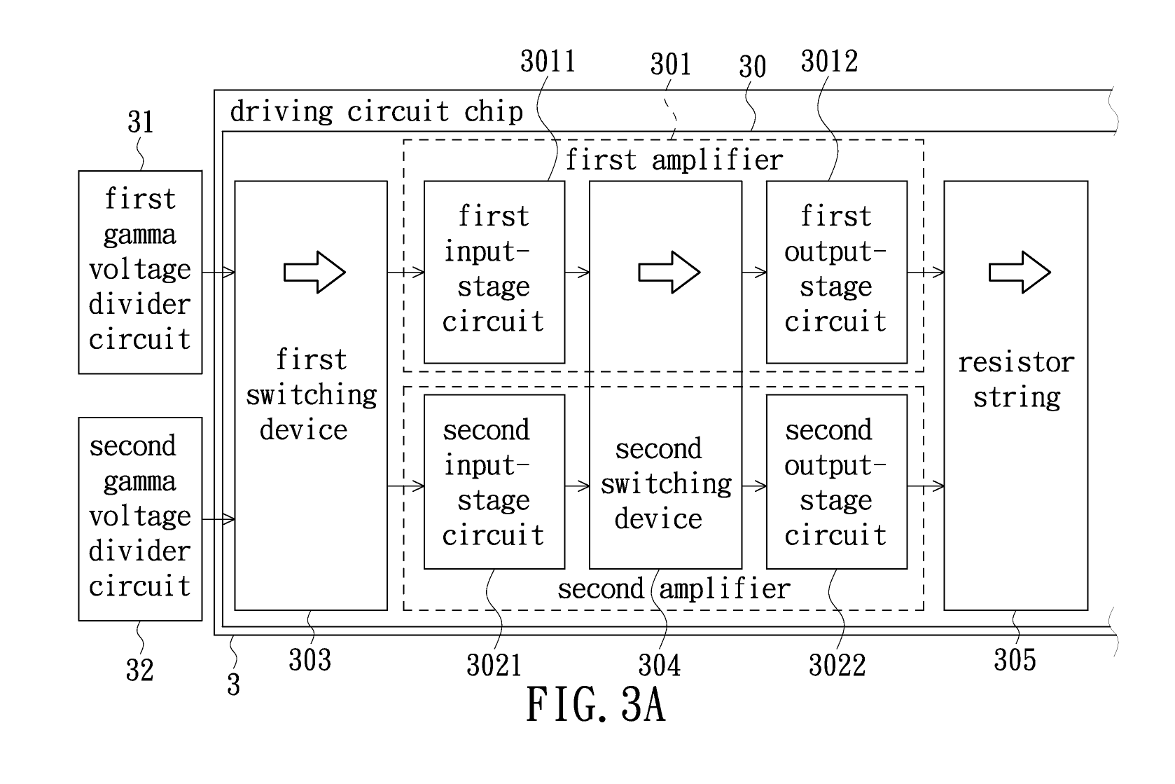

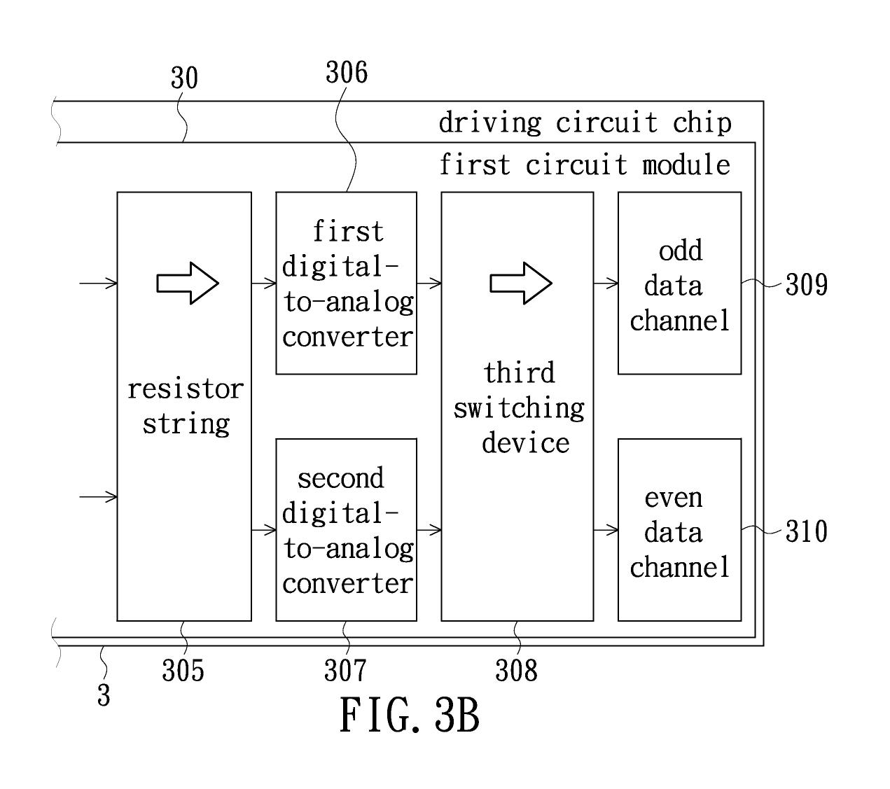

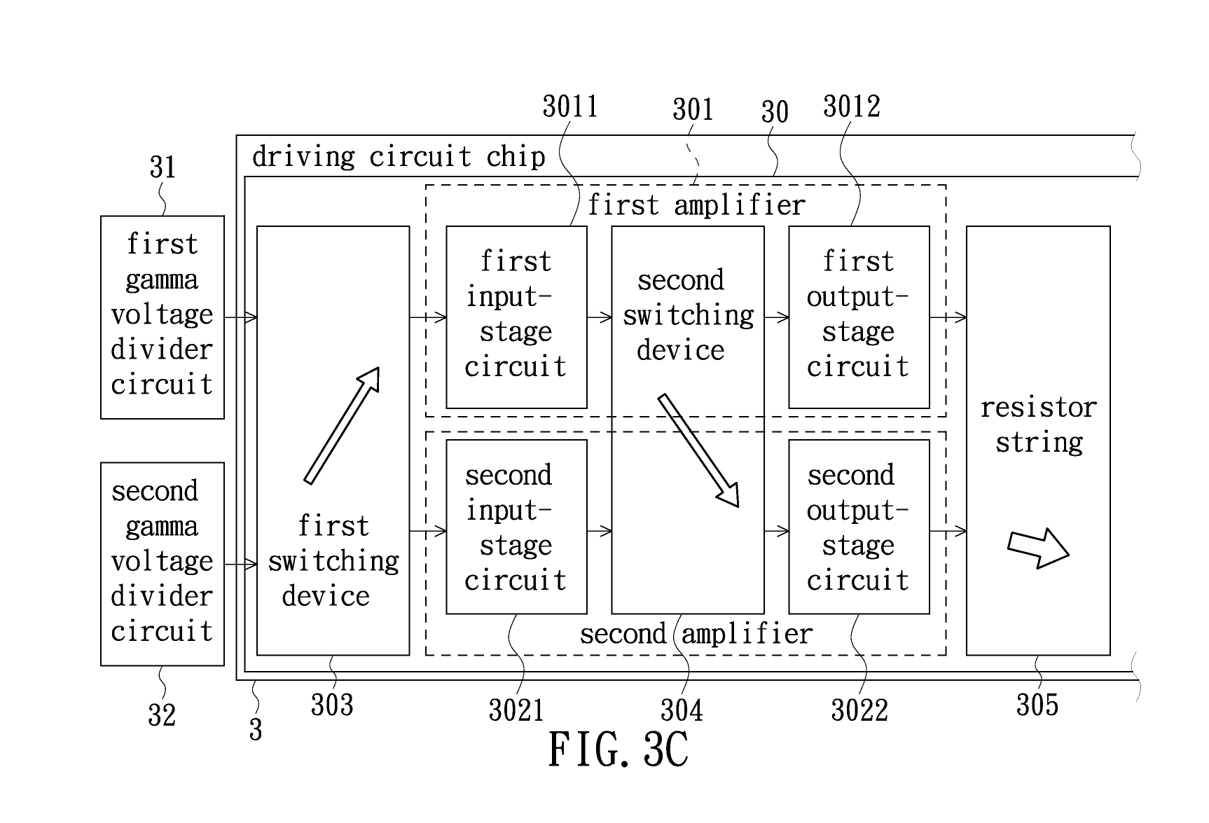

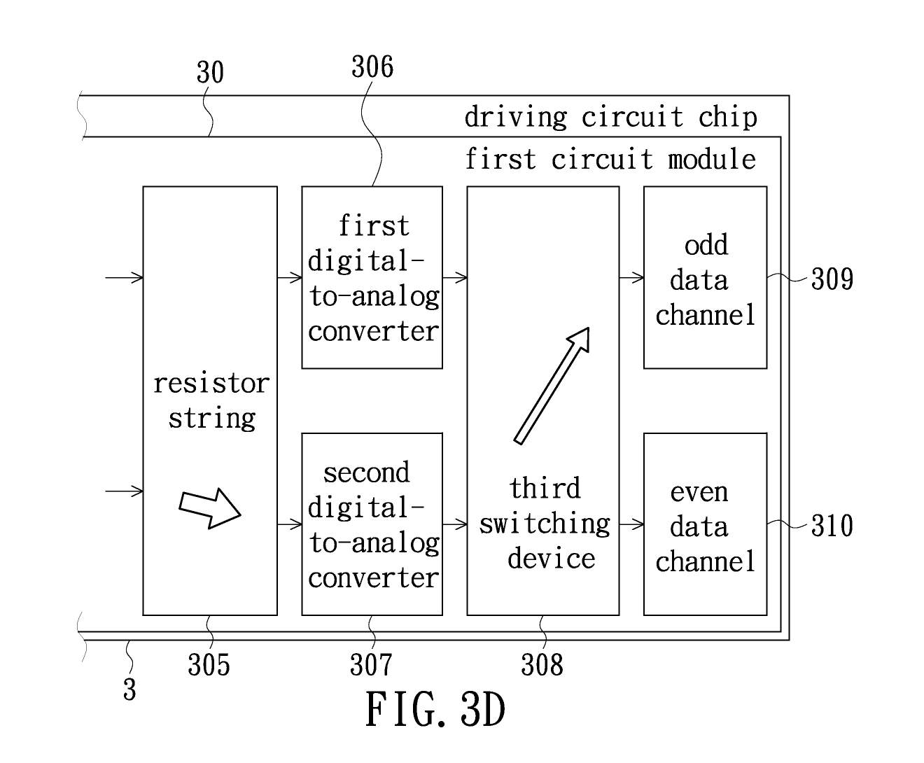

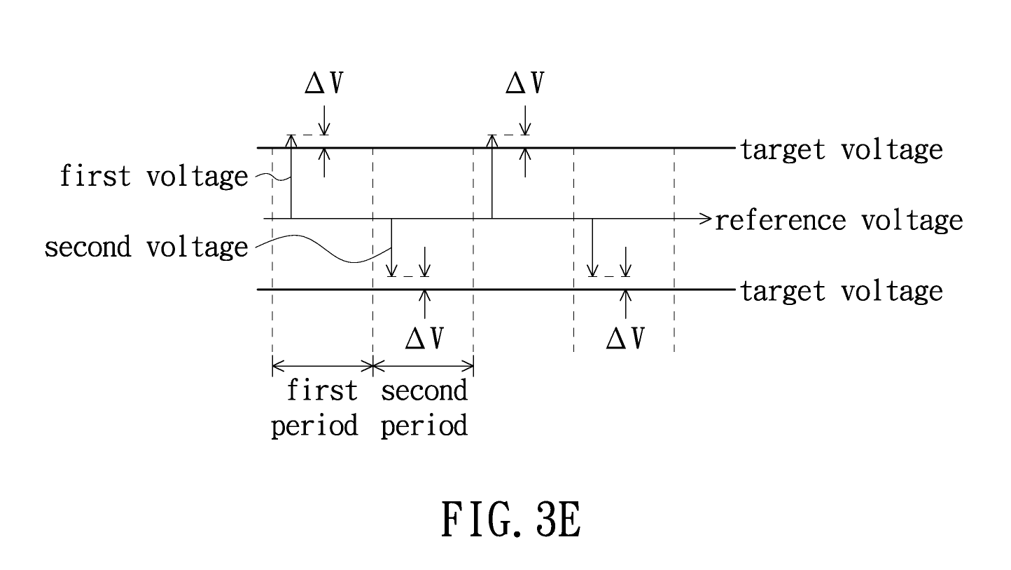

According to the aforementioned configuration, the operation process and effect of the signals in the driving circuit chip 3 may be illustrated in FIGS. 3A, 3B, 3C AND 3d. Specifically, the aforementioned adjacent first and second periods each may be an image updating period of the display apparatus and the display apparatus is configured to have an image updating speed of, for example, 60 frames per second; accordingly, both of the first period and the second period are configured to have a duration of 1/60 second. In addition, the data line (the odd data line or the even data line) of the display apparatus is configured to have the opposite polarities in each two consecutive image updating periods. In other words, a specific data line of the display apparatus is supplied with a positive reference voltage and a negative reference voltage in the first period and the second period, respectively.

Taking the odd data channel 309 as an example. In the first period as illustrated in FIGs. 3A, 3B, the positive first voltage VGMA1 is outputted after being sequentially transmitted via the first input-stage circuit 3011 and the first output-stage circuit 3012 of the first amplifier 301. The first amplifier 301 is assumed to have an offset voltage ΔV herein due to the manufacturing process variations, accordingly the reference voltage outputted from the first output-stage circuit 3012 in the first period has a value of the first voltage VGMA1+ΔV. The reference voltage outputted from the first output-stage circuit 3012 is then provided to the first digital-to-analog converter 306 for use after being processed by the resistor string module 305; and consequentially the converted first analog voltage is outputted to the odd data channel 309 via the third switching device 308.

In the second period as illustrated in FIGS. 3C, 3D, the negative second voltage VGMA14 is outputted after being sequentially transmitted via the first input-stage circuit 3011 of the first amplifier 301 and the second output-stage circuit 3022 of the second amplifier 302; and accordingly the reference voltage outputted from the second output-stage circuit 3022 in the second period has a value of the second voltage VGMA14+ΔV. The reference voltage outputted from the second output-stage circuit 3022 is then provided to the second digital-to-analog converter 307 for use after being processed by the resistor string module 305; and consequentially the converted second analog voltage is outputted to the odd data channel 309 via the third switching device 308.

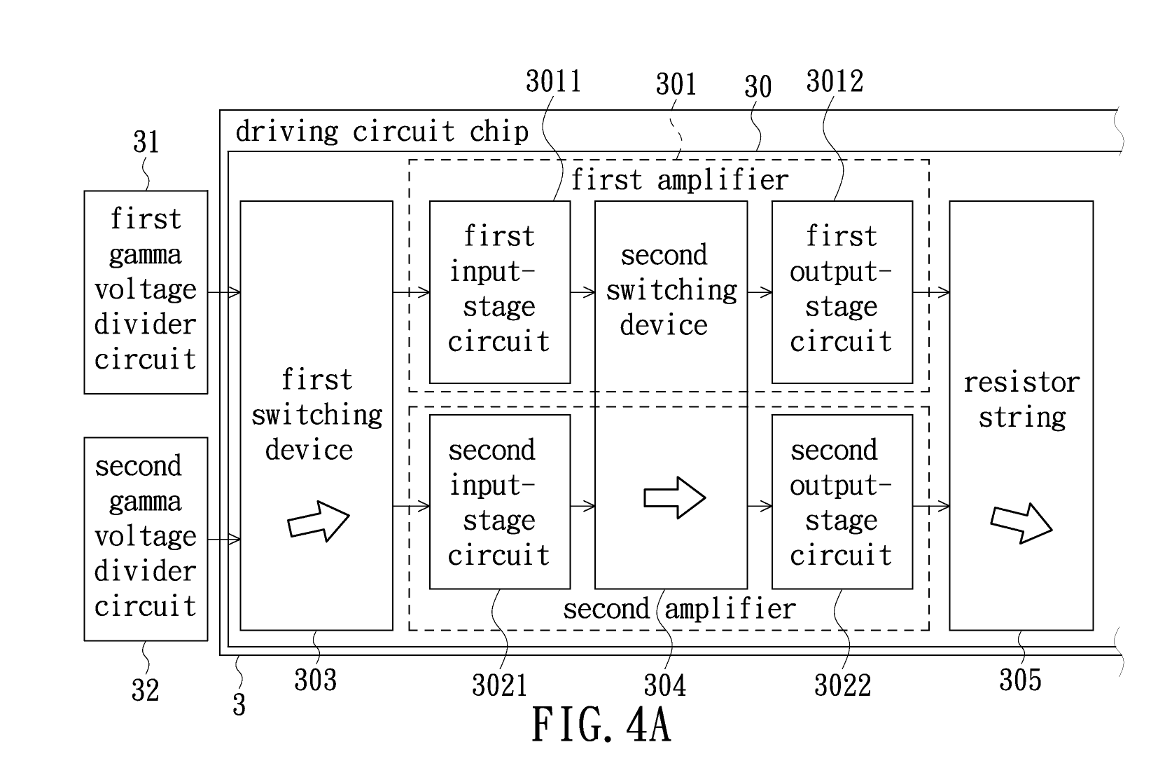

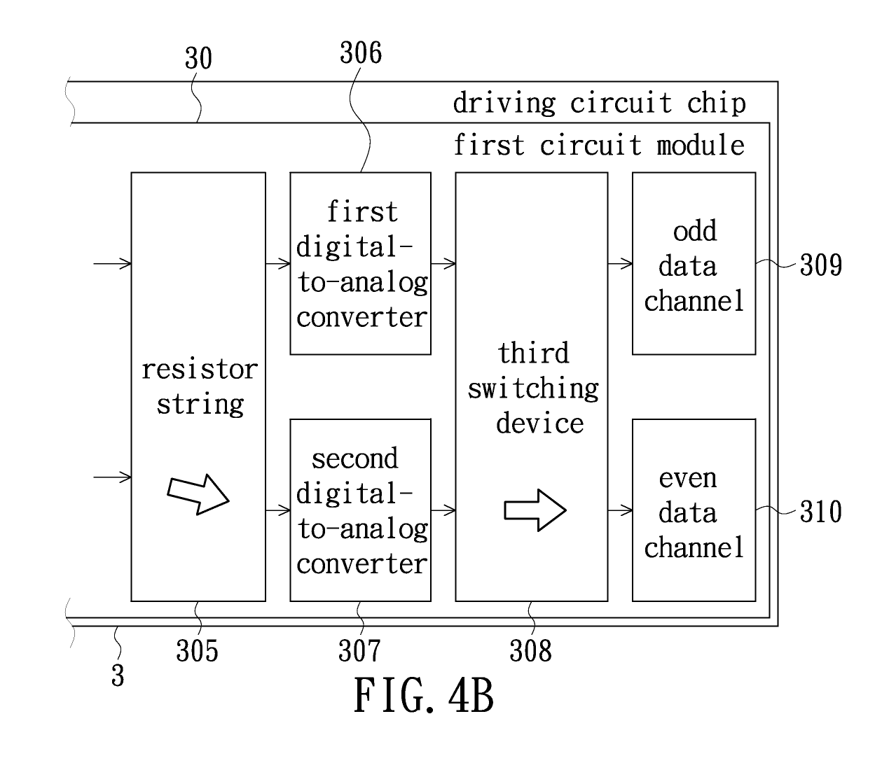

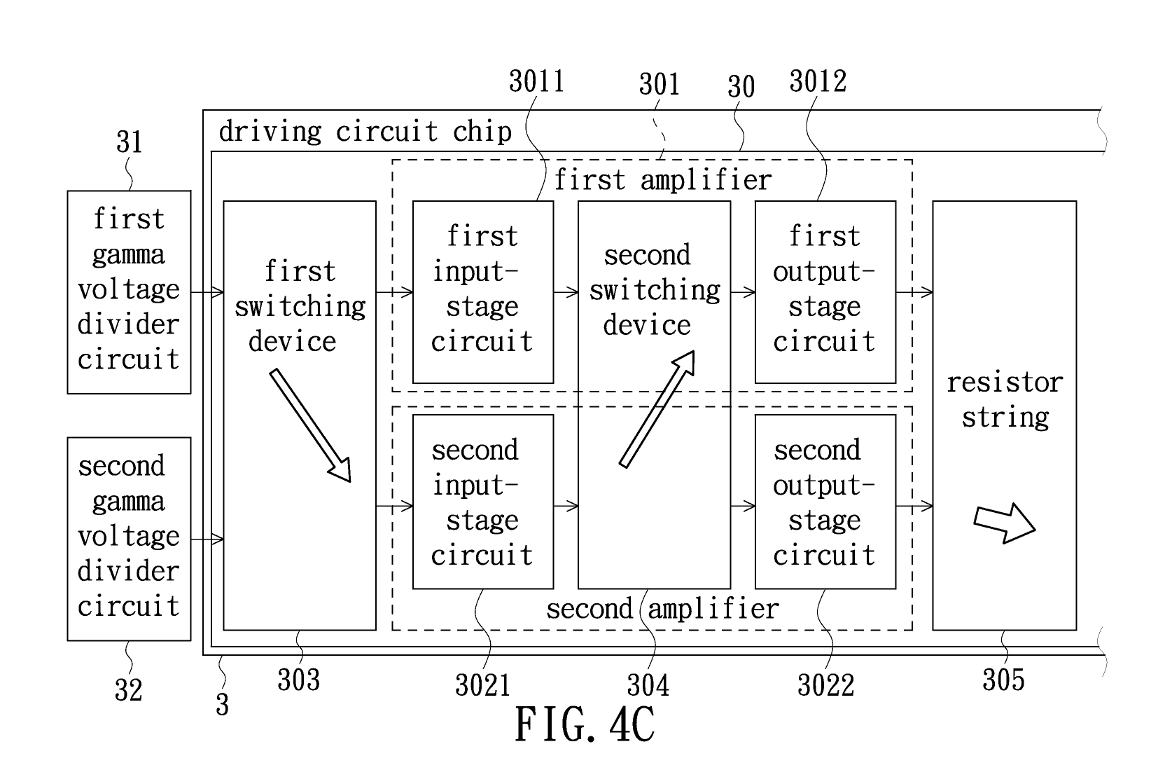

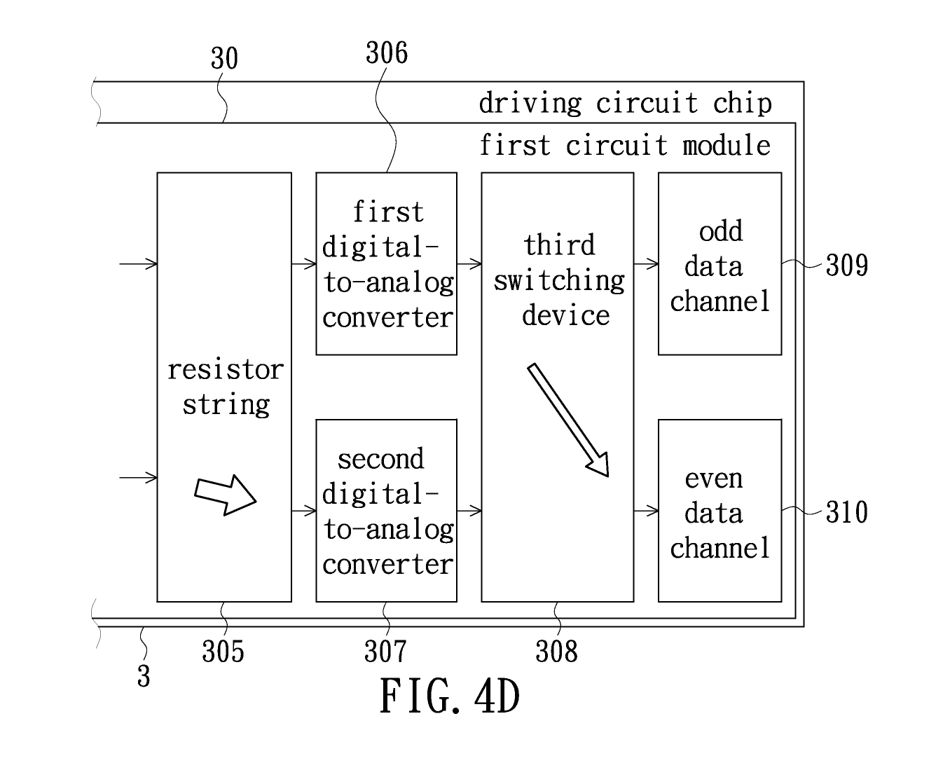

According to the voltage variations of the reference voltages illustrated in FIG. 3E, it is to be noted that the offset voltages ΔV of the first amplifier 301 added to the positive first voltage VGMA1 and the negative second voltage VGMA14 can be compensated and eliminated to each other in the next image updating period. Thus, the driving circuit chip 3 has an improved ability to eliminate the V-band and is capable of tolerating a greater offset voltage ΔV. The operating condition of the even data channel 310 is similar to that of the odd data channel 309 and will be described in detail in FIGS. 4A, 4B 4C and 4D. In addition, the pair voltages VGMA2 and VGMA13, . . . , and VGMA7 and VGMA8 have the similar processing mean, and no redundant detail is to be given herein.

In the first period as illustrated in FIGS. 4A, 4B, the negative second voltage VGMA14 is outputted after being sequentially transmitted via the second input-stage circuit 3021 and the second output-stage circuit 3012 of the second amplifier 302. The second amplifier 302 is assumed to have an offset voltage ΔV2 herein due to the manufacturing process variations, accordingly the reference voltage outputted from the second output-stage circuit 3022 in the first period has a value of the second voltage VGMA14+ΔV2. The reference voltage outputted from the second output-stage circuit 3022 is then provided to the second digital-to-analog converter 307 for use after being processed by the resistor string module 305; and consequentially the converted second analog voltage is outputted to the even data channel 310ia the third switching device 308.

In the second period as illustrated in FIGS. 4C, 4D, the positive first voltage VGMA1 is outputted after being sequentially transmitted via the second input-stage circuit 3021 of the second amplifier 302 and the first output-stage circuit 3012 of the first amplifier 301; and accordingly the reference voltage outputted from the first output-stage circuit 3012 in the second period has a value of the first voltage VGMA1+ΔV2. The reference voltage outputted from the first output-stage circuit 3012 is then provided to the first digital-to-analog converter 306 for use after being processed by the resistor string module 305; and consequentially the converted first analog voltage is outputted to the even data channel 310 via the third switching device 308.

Summary, by configuring the switching device to switch the signal transmission path, the driving circuit chip and the driving method is capable of compensating the offset voltage in the adjacent first and second periods, eliminating the V-band and tolerating a greater offset voltage.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A driving circuit chip, comprising:
a first amplifier comprising a first input-stage circuit and a first output-stage circuit;
a second amplifier comprising a second input-stage circuit and a second output-stage circuit;
a first switching device electrically connected to a first gamma voltage divider circuit, a second gamma voltage divider circuit, the first amplifier and the second amplifier, the first switching device being configured to receive a first voltage and a second voltage respectively outputted from the first gamma voltage divider circuit and the second gamma voltage divider circuit; output the first voltage and the second voltage to the first input-stage circuit of the first amplifier and the second input-stage circuit of the second amplifier, respectively, in a first period; and output the first voltage and the second voltage to the second input-stage circuit of the second amplifier and the first input-stage circuit of the first amplifier, respectively, in a second period; and
a second switching device electrically connected to the first amplifier and the second amplifier, the second switching device being configured to receive a third voltage and a fourth voltage respectively outputted from the first input-stage circuit of the first amplifier and the second input-stage circuit of the second amplifier; output the third voltage and the fourth voltage to the first output-stage circuit of the first amplifier and the second output-stage circuit of the second amplifier, respectively, in the first period; and output the third voltage and the fourth voltage to the second output-stage circuit of the second amplifier and the first output-stage circuit of the first amplifier, respectively, in the second period.

2. The driving circuit chip according to claim 1, wherein both of the first amplifier and the second amplifier are a negative feedback operational amplifier.

3. The driving circuit chip according to claim 1, wherein the first voltage and the second voltage received by the first switching device are configured to have the same amplitude but have the opposite polarities.

4. The driving circuit chip according to claim 1, wherein the driving circuit is used with a display apparatus, the display apparatus is configured to have an image updating speed of N frames per second, both of the first period and the second period are configured to have a duration of 1/N second, and the first period is adjacent to the second period.

5. The driving circuit chip according to claim 1, further comprising:
a resistor string module, electrically connected between the first output-stage circuit of the first amplifier and the second output-stage circuit of the second amplifier, configured to convert a fifth voltage outputted from the first output-stage circuit and a sixth voltage outputted from the second output-stage circuit into a first group of reference voltage and a second group of reference voltage, respectively;
a first digital-to-analog converter, electrically connected to the resistor string module, configured to perform a digital-to-analog conversion on a first digital data with reference of the first group reference voltage;
a second digital-to-analog converter, electrically connected to the resistor string module, configured to perform the digital-to-analog conversion on a second digital data with reference of the second group reference voltage;
an odd data channel electrically connected to an odd data line of a display apparatus;
an even data channel electrically connected to an even data line of the display apparatus; and
a third switching device electrically connected to the first digital-to-analog converter, the second digital-to-analog converter, the odd data channel and the even data channel, the third switching device being configured to receive a first analog voltage outputted from the first digital-to-analog converter and a second analog voltage outputted from the second digital-to-analog converter; output the first analog voltage and the second analog voltage to the odd data channel and the even data channel, respectively, in the first period; and output the second analog voltage and the first analog voltage to the odd data channel and the even data channel, respectively, in the second period.

6. A driving method for a display apparatus used in a driving circuit chip, the display apparatus comprising a first gamma voltage divider circuit and a second gamma voltage divider circuit, the driving circuit chip comprising a first amplifier and a second amplifier, the first amplifier comprising a first input-stage circuit and a first output-stage circuit, the second amplifier comprising a second input-stage circuit and a second output-stage circuit, the driving method comprising:
receiving a first voltage outputted from the first gamma voltage divider circuit and a second voltage outputted from the second gamma voltage divider circuit;
outputting the first voltage and the second voltage to the first input-stage circuit of the first amplifier and the second input-stage circuit of the second amplifier, respectively, in a first period;
outputting the first voltage and the second voltage to the second input-stage circuit of the second amplifier and the first input-stage circuit of the first amplifier, respectively, in a second period;
receiving a third voltage outputted from the first input-stage circuit of the first amplifier and a fourth voltage outputted from the second input-stage circuit of the second amplifier;
outputting the third voltage and the fourth voltage to the first output-stage circuit of the first amplifier and the second output-stage circuit of the second amplifier, respectively, in the first period; and
outputting the third voltage and the fourth voltage to the second output-stage circuit of the second amplifier and the first output-stage circuit of the first amplifier, respectively, in the second period.

7. The driving method according to claim 6, wherein the first voltage and the second voltage are configured to have the same amplitude but have the opposite polarities.

8. The driving method according to claim 6, wherein the display apparatus is configured to have an image updating speed of N frames per second, both of the first period and the second period are configured to have duration of 1/N second, and the first period is adjacent to the second period.

9. The driving circuit according to claim 8, further comprising:
converting a fifth voltage outputted from the first output-stage circuit and a sixth voltage outputted from the second output-stage circuit into a first group of reference voltage and a second group of reference voltage, respectively;
performing a digital-to-analog conversion on a first digital data with reference of the first group reference voltage and thereby forming a first analog voltage;
performing the digital-to-analog conversion on a second digital data with reference of the second group reference voltage and thereby forming a second analog voltage;
receiving the first analog voltage and the second analog voltage;
outputting the first analog voltage and the second analog voltage to an odd data channel and an even data channel, respectively, in the first period; and
outputting the second analog voltage and the first analog voltage to the odd data channel and the even data channel, respectively, in the second period.
